(19) United States
(12) Patent Application Publication
(10) Pub. No.: US 2009/0283478 A1
(43) Pub. Date: Nov. 19, 2009

(54) METHOD AND SYSTEM FOR A REGENERATIVE PARTICLE TRAP STRUCTURE LOADED AND UNLOADED WITH ACTIVE MATERIALS BY WAY OF A FLOW STREAM

(75) Inventor: Gideon ROSENBERG, Tiveon (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: MILOW LTD., Charleston, SC (US)

(21) Appl. No.: 12/464,900

(22) Filed: May 13, 2009

Related U.S. Application Data
(60) Provisional application No. 61/127,501, filed on May 15, 2008.

(51) Int. Cl. C02F 1/28; C02F 9/02

(52) U.S. Cl. 210/678; 210/275; 210/252

(57) ABSTRACT

A method and system for treating a fluid by trapping particles of an active material suspended in a flow stream by way of a particle-trap structure so as to form a multi-layer filtering media to treat the fluid. The particle trap is fully regenerative configured so that the particles are readily back flushed after achieving their absorption capacity in preparation for loading a fresh charge of active particles. The method also describes a combination of a centrifuge separator in-line with the regenerative particle trap configured such that the separator first removes contaminants of considerably different specific gravity than the fluid and the regenerative active particle trap then removes the remaining contaminants by absorption or chemical treatment.

### FIELD AND BACKGROUND OF THE INVENTION

The present invention relates to a method and a system for treating constituents (e.g., oil, coolants such as glycols, ether) from water or other liquids, and particularly, relates to a regenerative active particle treatment system employing an active particle trap-structure for trapping active and/or absorbent particles suspended in a flow stream passing through a particle trap structure and for removing spent particles by a flow stream in the opposite direction.

It is well known that mixtures of organic substances and water create serious environmental problems. For example, bilge water in amphibious vehicles contains diesel fuel, hydraulic oil, engine oil, transmission oil, and ethylene and propylene glycol coolants. Similar environmentally problematic mixtures are found in landing crafts, ferryboats, and in water used to clean oil tankers after dispatch. Environment regulations strictly forbid dumping of such mixtures into the sea or onto the shore. Oil refineries and petrochemical industry also create huge amounts of contaminated water that must be treated before drainage.

Existing decontamination techniques involve storing bilge water and other similar waste hazards in storage drums or large sinking tanks employing gravity and leveled partitions to separate contaminants according to specific gravity. These methods require a final filtration stage at some point, which is usually performed by way of disposable filters, thereby giving rise to additional environment hazards when disposing the spent filters.

There is, therefore, a need for system for removing undesirable constituents from liquids in a manner that does not require storage facilities and does not create additional environmental hazards.

The present invention describes a method and system for separating, filtering and treating contaminants from bilge water, or other flow streams having undesired constituents using a continuous in-line process for removing contaminants during pumping. The system includes a regenerative particle-trap structure loadable with particles of active, absorbent active and absorbent, or absorbent particles with absorbent particles to form a multi-layer filtration/treatment arrangement for absorbing and/or chemically treating the flow stream for those undesired elements in the flow stream. The system is fully regenerative in which fresh, active/absorbent material is replenished at periodic intervals to renew the particle trap-structure treatment capability.

### SUMMARY OF THE INVENTION

The present invention is a method and system of filtering or treating a flow stream by way of a filter loaded by trapping, active/absorbent particles suspended in a flow stream passing through a particle trap in a way that the trapped particles reside in said filter traps while forming additional inner active/absorbent filtration media. The filtering method is also regenerative by a way of unloading the trapped active/absorbent particles in a way of flushing by flow stream in the opposite direction.

According to the teachings of the present invention there is provided, a method for loading solid particles of an active material into a particle-trap structure by way of a liquid flow stream comprising: a) providing said particle-trap structure in a liquid flow line for trapping particles of an active material suspended in a liquid flow stream passing through said trap structure, said trap structure having a plurality of flow paths each of said flow paths having a flow constriction constituting a plurality of discrete miniature passageways for the fluid flow and to arrest solid particles, disposed within said flow path so that: i ) the solid particles are prevented from passing through said passageways, and ii) an accumulation of the solid particles is formed in each of said flow paths upstream from said flow constriction where the particles form a plurality of multi-layer media that resides therein until a back flow is applied to said particle-trap structure, b) introducing said solid particles of an active material into the liquid flow stream upstream from said particle-trap structure, specified by the sizes of all said particles that must be greater than the dimension of said passageways, so that when a liquid flow stream passes through said trap-structure the solid particles of active material are trapped in said trap-structure so as to form a plurality of active-media layers for treating a liquid flow stream containing undesired constituents.

According to a further feature of the present invention, there is also provided applying a back flow of liquid to said trap-structure so as to remove said accumulation of the solid particles from said trap-structure in preparation of reloading of said particle-trap structure with additional solid particles of an active medium.

According to a further feature of the present invention the applying a back flow of liquid includes redirecting a portion of the flow stream previously treated by said plurality of active-media layers.

According to a further feature of the present invention the solid particles of an active material are selected from the group consisting of activated carbon, clay, polyphosphate glass and sodium silicate.

There is also provided according to the teachings of the present invention, a system for treating a liquid flow stream containing undesired constituents comprising: (a) a particle-trap structure deployed in a liquid flow line for trapping particles of an active material suspended in the liquid flow stream passing through said trap structure, said trap structure having a plurality of flow paths, each of said flow paths having a flow constriction constituting a plurality of discrete miniature passageways having a size allowing fluid flow and arresting solid particles disposed within said flow path so that: i ) the solid particles are prevented from passing through said flow path, and ii) an accumulation of the solid particles is formed in each of said flow paths upstream from said flow constriction and form a plurality of multi-layer media that resides therein until a back flow is applied to said particle-trap structure, and (b) an injection arrangement deployed immediately upstream from said particle-trap structure for introducing solid particles of an active material into the flow stream said solid particles having a size exceeding the size of said passageways so that the solid particle are trapped in said particle-trap structure forming a plurality of layers of active media for treating a flow stream containing undesired constituents.

According to a further feature of the present invention, there is also provided a back flush arrangement for directing a backflow against said particle-trap structure thereby releasing the solid particles accumulated in said particle-trap structure.

According to a further feature of the present invention, the back flush arrangement includes a configuration that redirects a portion of the flow stream previously treated by said multi-layer active media.

According to a further feature of the present invention, the solid particles of an active material are selected from the group consisting of activated carbon, clay, polyphosphate glass and sodium silicate.

There is also provided according to the teachings of the present invention, system for treating a liquid flow stream including a carrier liquid having a specific gravity and undesired constituents comprising: (a) a particle-trap structure deployed in a liquid flow line for trapping particles of an active material suspended in the liquid flow stream passing through said trap structure, said trap structure having a plurality of flow paths, each of said flow paths having a flow constriction constituting of a plurality of discrete miniature passageways for the fluid flow and to arrest solid particles disposed within said flow path so that: i) the solid particles are prevented from passing through said flow path, and ii) an accumulation of the solid particles is formed in each of said flow paths upstream from said flow constriction and form a plurality of multi-layer media that resides therein where the particles remain until a back flow is applied against said particle-trap structure, (b) an injection arrangement deployed in the liquid flow line immediately upstream from said particle-trap structure for introducing solid particles of an active material into the flow stream, and (c) a centrifuge separator deployed upstream from said injection arrangement, said centrifuge separator being configured to remove elements in the flow stream having a specific gravity different than the specific gravity of the liquid flow stream thereby ensuring that the undesired constituents remaining in the flow stream have a specific gravity approaching the specific gravity of the carrier liquid.

According to a further feature of the present invention, there is also provided a back flush arrangement for directing a backflow against said particle-trap structure thereby releasing the solid particles accumulated in said particle trap structure

According to a further feature of the present invention, the back flush arrangement includes an arrangement that redirects a portion of the flow stream previously treated by said plurality of layers of active media.

According to a further feature of the present invention, the solid particles of an active material are selected from the group consisting of activated carbon, clay, polyphosphate glass and sodium silicate.

### BRIEF DESCRIPTION OF THE DRAWINGS

The invention is herein described, by way of example only, with reference to the accompanying drawings, wherein:

FIGS. 1 and 2 are isometric, partial-cutaway, top-views depicting the direction of the fluid flow during filter loading and flushing in an exemplary particle trap structure, respectively

FIG. 3 is a schematic diagram of an exemplary treatment system employing the filter loaded by way of a flow stream in line with a centrifuge separator.

FIG. 4 is a general schematic, transparent top view depicting particle-trap structure and associated back flush arrangement

### DESCRIPTION OF THE PREFERRED EMBODIMENTS

The present invention describes a method of loading a filter by way of a liquid stream flow and a treatment system employing such a method. As mentioned above, the current invention has applications in the decontamination of bilge water and other mixtures of water and organic pollutants, however, it should be noted that the removal of any undesired component mixed into a liquid flow stream is also within the scope of the current invention.

Furthermore, it should be appreciated that the current invention employs active filtering in which the undesirable constituents are removed from the flow stream on the basis of an affinity between the active filtering medium and the undesirable constituents as opposed to mechanically trapping based on the physical dimensions of the filtered element exceeding size of the interstices between in the filtering medium. Typically, materials such as activated carbon, clay, or water treatment materials such as polyphosphate glass (commonly know by its brand name SILIPHOS®), and sodium silicate are employed as the loaded particles; however, any material possessing absorptive or chemically active properties used in water treatment is within the scope of this invention.

The principles and operation of the method according to the present invention may be better understood with reference to the drawings and the accompanying description.

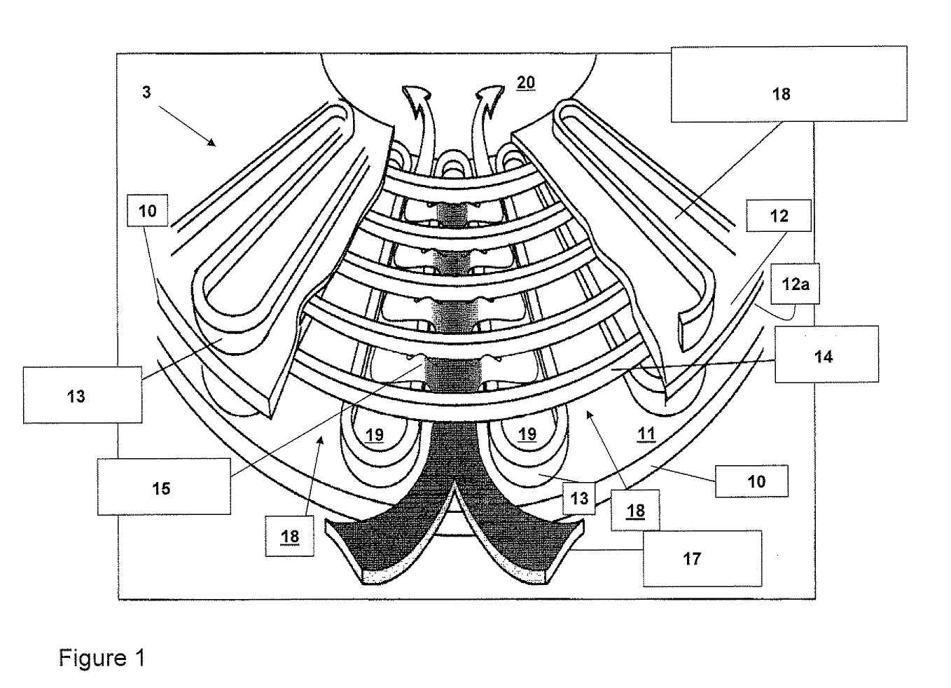

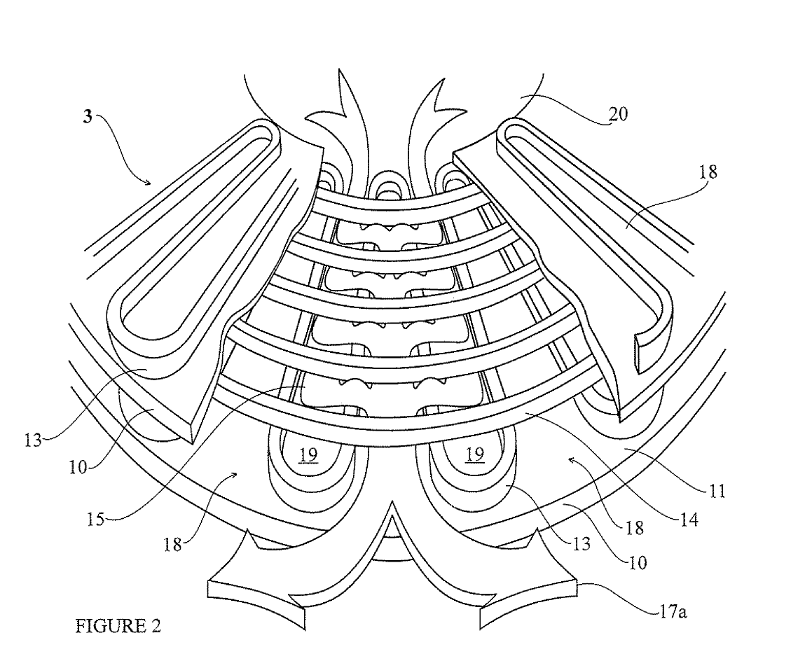

FIGS. 1 and 2 depict an exemplary, non-limiting embodiment of a particle trap structure formed between filtration disks with the direction of flow shown during loading and flushing of the particle filter, respectively. Prior art documents, U.S. Pat. No. 5,797,978, and U.S. Pat. No. 6,391,097 that disclose a disk filter for removing solid particles from a fluid passing from the inlet to the outlet. Those documents are hereby incorporated by reference in their entirely as if fully set out herein. Particle trap-structure, generally designated 3, consists of a plurality of ring shaped disks 10 stacked so that the face 11 of each disk 10 is substantially parallel with the face 12 of adjacent disk 10. A continuous sinuous rib 13 is integrally formed on each face 11 and 12 of disks 10 to define a series of spaced, radial paths 18 for directing the upstream flow and a series of spaced, radial paths 19 for directing the downstream flow. A series of annular ribs 14, concentric or spiral, disposed on a second face 12a of each disk 10 further encloses flow paths 18 and 19 when disks 10 are in their stacked configuration and the spacing between annular ribs 14 creates a series of miniature passageways 15 connecting adjacent radial flow paths 18 and 19 as shown in FIGS. 1 and 2. Each rib 14 protrudes from a second face 12a of disks 10 at the same amount and each radial space between any adjacent ribs is identical, so that all passageways 15 have exactly the same dimension thereby defining the filtration mesh grade. In a non-limiting, exemplary embodiment, sinuous rib 13 protrudes from disk face 11 about 0.5 millimeters whereas annular ribs 14 protrude from disk face 12a about 5 microns and the radial spaces between adjacent annular ribs are about 50 microns. The dimensions of each passageway 15 is accordingly 5×50 microns so that particles exceeding 6 microns in diameter (or for other shapes: in its smaller size) are prevented from passing through passageways 15 and therefore are trapped and accumulate in the flow paths 18 forming additional multilayer of filtering media. Undesirable constituents in oncoming flow stream 17 are absorbed by the activated particles accumulated in flow paths 18 while the carrier liquid passes through the interstices between the absorbent particles, exits flow path 18 by way of miniature passageways 15 into flow path 19, continues radially inwards, and feeds into axial flow stream 20 as shown in FIG. 1.

FIG. 2 depicts the reverse fluid flow 17a during back flush of particle-trap structure 3 in which the trapped filtering particles and the absorbed contaminates are released from trap structure 3 and disposed of (not shown) in preparation for re-loading a fresh charge of absorbent particles in fully regenerative manner. It should be noted that the back flush may be provided manually or automatically in response to a pressure drop across the filter, or in response to a gauging the quality of the output as indication of the ineffectiveness of the absorbent, or in response to a flow meter indicating the passage of a pre-determined flow quantity; are all within the scope of the current invention.

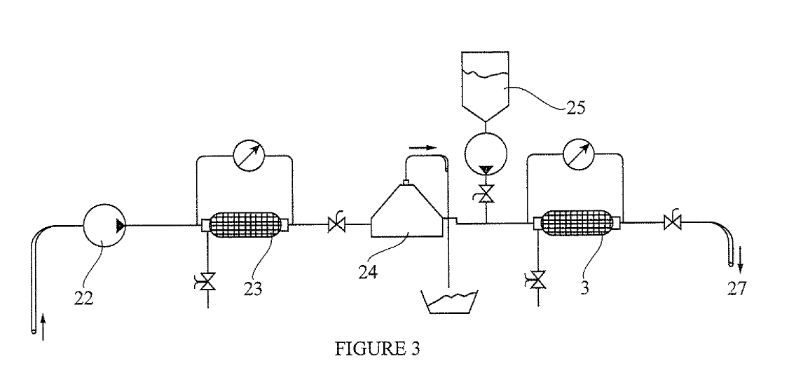

FIG. 3 depicts a decontamination system in which the self-loading filter is deployed in a synergistic arrangement with other in-line separation and particle injection devices. In a non-limiting, exemplary embodiment, the system includes a pump 22 for intaking liquid 21, a first filter 23 and associated drain and differential pressure gage for removing solid particles capable of damaging centrifuge separator 24, a centrifuge separator 24 for separating fluids having a specific gravity significantly different than carrier liquid 21, a mixer 25 and injector injecting absorbent particles or a suspension of absorbent particles into flow stream 21, stream-loaded filter 3 for trapping the suspended absorbent particles so as to form a regenerative filter and associated drain and differential pressure gage.

The flow stream is pumped into the system by an ordinary centrifuge pump 22, and then filtered by filter 23 having a mesh grade suitable for removing solid particles of sufficient size to damage centrifuge separator 24 deployed downstream. Flow stream 21 is then centrifuged by centrifuge separator 24 to remove fluid contaminants having a specific gravity sufficiently different than that of carrier liquid 21. A Mixer/Injector 25 is used for frequent injection of active/absorbent particles into a flow stream 21 immediately upstream from stream-loaded filter 3. The suspended particles are trapped in particle-trap structure 3 so as to form additional residing multi-layer filtering media as the flow stream passes through particle trap structure 3 described above. Undesirable elements in the flow stream contacting the multi-layer filter media as the flow stream passes through are then absorbed and the treated liquid discharged from the system. As mentioned above, when the filter reaches its absorptive capacity, the filter is back flushed and reloaded with a fresh charge of absorbent/active particles. Treated flow stream 27 then exits the system.

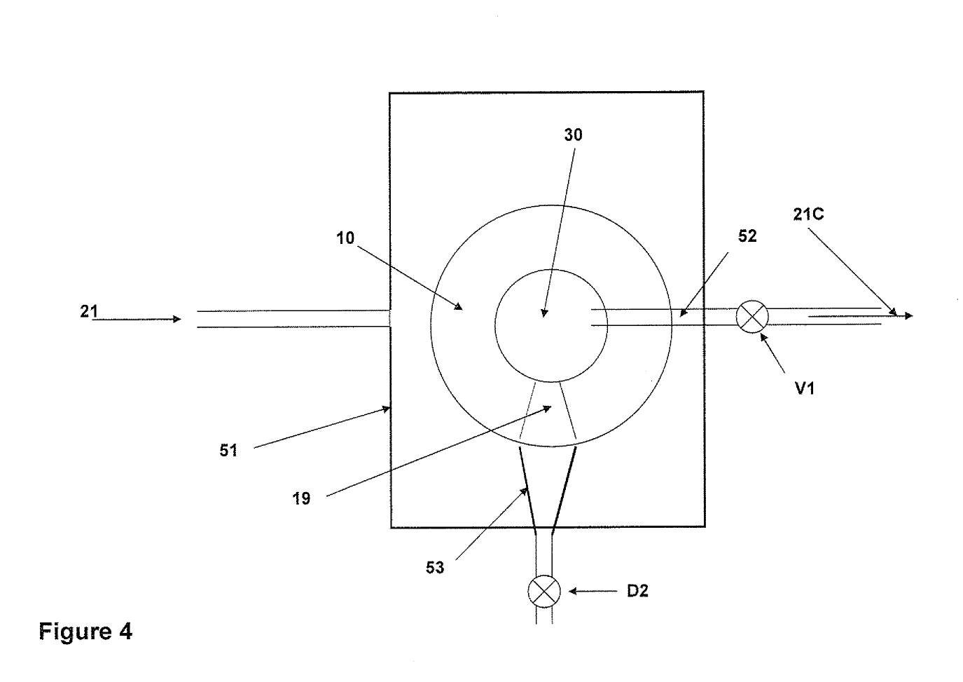

FIG. 4 is a block diagram depicting particle-trap structure and associated back flush arrangement such that the reverse flow stream being used for the back flush constitutes of clean fluid that was filtered on line during the back flush operation. Prior art document U.S. Pat. No. 5,575,911, teaching an integrated back flush arrangement integrated into a particle filter arrangement, is hereby incorporated by reference in its entirety as if fully set out herein. The illustration of FIG. 4 is schematically demonstrating this principle. A flow stream 21 is entering the filter body, being filtered by stack of discs 10 and the clean stream designated 21C is flowing out via tube 52 which is connected to the inner side 30 of the disc stack. Control valve V1 is open during the filtration mode and drain valve D2 is kept closed at the same time. One sector of the discs designated 19 is not filtering since the upstream flow into it is prevented by the blocking ribs 53. In order to operate the back-flush, the drain valve D2 is opened and the control valve V1 is preferably closed to utilize all the pressure for the back flow stream. At this position the clean fluid from space 30 is creating a flow stream through sector 19 and drained out via valve D2. The disc stack is then rotated so that other areas of disc 10 are replacing sector 19 and therefore being flushed/cleaned by the reverse flow through ribs 53.

Alternately, a back flush system disposed externally to the filter arrangement is within the scope of the current invention.

It will be appreciated that the above descriptions are intended only to serve as examples, and that many other embodiments are possible within the scope of the present invention as defined in the appended claim.

What is claimed is:

1. A method for loading solid particles of an active material into a particle-trap structure byway of a liquid flow stream comprising:
a) providing said particle-trap structure in a liquid flow line for trapping particles of an active material suspended in a liquid flow stream passing through said trap structure, said trap structure having a plurality of flow paths each of said flow paths having a flow constriction constituting a plurality of discrete miniature passageways for the fluid flow and to arrest solid particles, disposed within said flow path so that:
i. the solid particles are prevented from passing through said passageways, and
ii. an accumulation of the solid particles is formed in each of said flow paths upstream from said flow constriction where the particles form a plurality of multi-layer media that resides therein until a back flow is applied to said particle-trap structure,
b) introducing said solid particles of an active material into the liquid flow stream upstream from said particle-trap structure, specified by the sizes of all said particles that must be greater than the dimension of said passageways, so that when a liquid flow stream passes through said trap-structure the solid particles of active material are trapped in said trap-structure so as to form a plurality of active-media layers for treating a liquid flow stream containing undesired constituents.

2. The method of claim 1 further comprising applying a back flow of liquid to said trap-structure so as to remove said accumulation of the solid particles from said trap-structure in preparation of reloading of said particle-trap structure with additional solid particles of an active medium.

3. The method of claim 2 wherein said applying a back flow of liquid includes redirecting a portion of the flow stream previously treated by said plurality of active-media layers.

4. The method of claim 1 wherein said solid particles of an active material are selected from the group consisting of activated carbon, clay, polyphosphate glass and sodium silicate.

5. A system for treating a liquid flow stream containing undesired constituents comprising:
a) a particle-trap structure deployed in a liquid flow line for trapping particles of an active material suspended in the liquid flow stream passing through said trap structure, said trap structure having a plurality of flow paths, each of said flow paths having a flow constriction constituting a plurality of discrete miniature passageways having a size allowing fluid flow and arresting solid particles disposed within said flow path so that:
i. the solid particles are prevented from passing through said flow path, and
ii. an accumulation of the solid particles is formed in each of said flow paths upstream from said flow constriction and form a plurality of multi-layer media that resides therein until a back flow is applied to said particle-trap structure, and
b) an injection arrangement deployed immediately upstream from said particle-trap structure for introducing solid particles of an active material into the flow stream said solid particles having a size exceeding the size of said passageways so that the solid particle are trapped in said particle-trap structure forming a plurality of layers of active media for treating a flow stream containing undesired constituents

6. The system of claim 5 further includes a back flush arrangement for directing a backflow against said particle-trap structure thereby releasing the solid particles accumulated in said particle-trap structure.

7. The system of claim 6 wherein said back flush arrangement includes a configuration that redirects a portion of the flow stream previously treated by said multi-layer active media.

8. The system of claim 5 wherein said solid particles of an active material are selected from the group consisting of activated carbon, clay, polyphosphate glass and sodium silicate.

9. A system for treating a liquid flow stream including a carrier liquid having a specific gravity and undesired constituents comprising:
a) a particle-trap structure deployed in a liquid flow line for trapping particles of an active material suspended in the liquid flow stream passing through said trap structure, said trap structure having a plurality of flow paths, each of said flow paths having a flow constriction constituting of a plurality of discrete miniature passageways for the fluid flow and to arrest solid particles disposed within said flow path so that:
i. the solid particles are prevented from passing through said flow path, and
ii. an accumulation of the solid particles is formed in each of said flow paths upstream from said flow constriction and form a plurality of multi-layer media that resides therein where the particles remain until a back flow is applied against said particle-trap structure,
b) an injection arrangement deployed in the liquid flow line immediately upstream from said particle-trap structure for introducing solid particles of an active material into the flow stream, and
c) a centrifuge separator deployed upstream from said injection arrangement, said centrifuge separator being configured to remove elements in the flow stream having a specific gravity different than the specific gravity of the liquid flow stream thereby ensuring that the undesired constituents remaining in the flow stream have a specific gravity approaching the specific gravity of the carrier liquid.

10. The system of claim 9 further comprising a back flush arrangement for directing a backflow against said particle-trap structure thereby releasing the solid particles accumulated in said particle-trap structure.

11. The system of claim 10 wherein said back flush arrangement includes an arrangement that redirects a portion of the flow stream previously treated by said plurality of layers of active media.

12. The system of claim 9 wherein said solid particles of an active material are selected from the group consisting of activated carbon, clay, polyphosphate glass and sodium silicate.
